(19) United States
(12) Patent Application Publication
(10) Pub. No.: US 2010/0223835 A1
(43) Pub. Date: Sep. 9, 2010

(54) BUOYANT FISHING TACKLE BOX AND PACKAGE THEREFOR

(76) Inventor: Wanda Connor, Longview, TX (US)

Correspondence Address: L.C. BEGIN & ASSOCIATES, PLLC, 510 HIGHLAND AVENUE, PMB 403, MILFORD, MI, 48381, US

(21) Appl. No.: 12/615,303

(22) Filed: Nov. 10, 2009

Related U.S. Application Data
(60) Provisional application No. 61/157,782, filed on Mar. 5, 2009.

(51) Int. Cl. A01K 97/06; B65D 85/00; B65D 88/78

(52) U.S. Cl. 43/54.1; 206/315.11; 220/560

(57) ABSTRACT

One embodiment of a buoyant fishing tackle box package is provided. The buoyant fishing tackle box package includes a buoyant fishing tackle box, a location detection system and a control device. The buoyant fishing tackle box includes a lower body member, an upper body member and a pair of handle members. The lower body member includes a weighted base portion which keeps the fishing tackle box in an upright position. The lower body member is hollow and substantially hemispherical in shape. The upper body member is hollow and substantially hemispherical in shape. The upper body member is removably engaged with the lower body member. The pair of handle members is attached to an outer surface of the lower body member. The location detection system is disposed on one of the lower body member and the upper body member. The control device is operatively coupled to the location detection system.

### CROSS REFERENCE TO RELATED APPLICATION

This application claims the benefit of U.S. Provisional Application No. 61/157,782 filed on Mar. 5, 2009, the disclosure of which is incorporated by reference.

### FIELD OF THE DISCLOSURE

The present disclosure generally relates to fishing tackles, and, more particularly to a buoyant fishing tackle box capable of floating in water.

### BACKGROUND OF THE DISCLOSURE

Typically, fishing tackles refer to various accessories used by an individual while fishing. Examples of the fishing tackles may include hooks, lines, sinkers, rods, reels, baits, lures, and the like. An individual, such as a fisherman may carry one or more of the fishing tackles in a fishing tackle box while fishing. The fishing tackle box offers the fisherman a simple and effective way to haul various fishing accessories in one compact unit.

Usually, while fishing the fisherman or any other individual may accidentally drop the fishing tackle box in water. The dropped fishing tackle box may sink in water and may get lost. In some cases, the fishing tackle box may not be located easily and accordingly, would necessitate a replacement of the same incurring additional cost. This aspect of lack of locating means of the dropped fishing tackle box requires improvement.

### SUMMARY OF THE DISCLOSURE

One embodiment of a buoyant fishing tackle box includes a lower body member, a complementary upper body member and a pair of handle members. The lower body member includes a weighted base portion and an open top end portion. Further, the lower body member is hollow and substantially hemispherical in shape, thereby defines a space therewithin. The space is partitioned to configure a plurality of compartments. Each compartment of the plurality of compartments is capable of holding at least one fishing tackle therein. The upper body member is hollow and substantially hemispherical in shape. The upper body member includes an open bottom end portion. The open bottom end portion of the upper body member can be removably configured with the open top end portion of the lower body member for disposing the upper body member on the lower body member. The pair of handle members is attached to an outer surface of the lower body member. The weighted base portion enables the buoyant fishing tackle box to remain in an upright position.

One embodiment of a buoyant fishing tackle box package includes a buoyant fishing tackle box, a location detection system and a control device. The buoyant fishing tackle box includes a lower body member, an upper body member and a pair of handle member. The lower body member includes a weighted base portion and an open top end portion. Further, the lower body member is hollow and substantially hemispherical in shape, thereby defining a space therewithin. The space is partitioned to configure a plurality of compartments. Each compartment of the plurality of compartments is capable of holding at least one fishing tackle therein. The upper body member includes an open bottom end portion. Further, the upper body member is hollow and substantially hemispherical in shape. The open bottom end portion of the upper body member is capable of being removably engaged with the open top end portion of the lower body member for disposing the upper body member on the lower body member. The pair of handle members is attached to an outer surface of the lower body member. The weighted base portion enables the buoyant fishing tackle box to remain in an upright position. Further, the location detection system is disposed either on the lower body member or on the upper body member of the buoyant fishing tackle box. The location detection system facilitates detection of a misplaced buoyant fishing tackle box. Furthermore, the buoyant fishing tackle box package includes a control device operatively coupled to the location detection system. The control device is capable of activating the location detection system.

### BRIEF DESCRIPTION OF THE DRAWINGS

The advantages and features of the present disclosure will become better understood with reference to the following detailed description and claims taken in conjunction with the accompanying drawing, in which:

FIG. 1 is a front view of one embodiment of a buoyant fishing tackle box;

FIG. 2 is a side view of the buoyant fishing tackle box of FIG. 1;

FIG. 3 is another embodiment of a buoyant fishing tackle box; and

FIG. 4 is a front view of one embodiment of a buoyant fishing tackle box package.

Like reference numerals refer to like parts throughout the description of several views of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular fishing tackle box as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

Further, the terms, “a” and “an” herein do not denote a limitation of quantity, but rather denote the presence of at least one of the referenced item.

The present disclosure provides a buoyant fishing tackle box. The buoyant fishing tackle box is capable of floating in water when dropped accidentally in the water while fishing. Further, the fishing tackle box is capable of being located easily when misplaced during fishing.

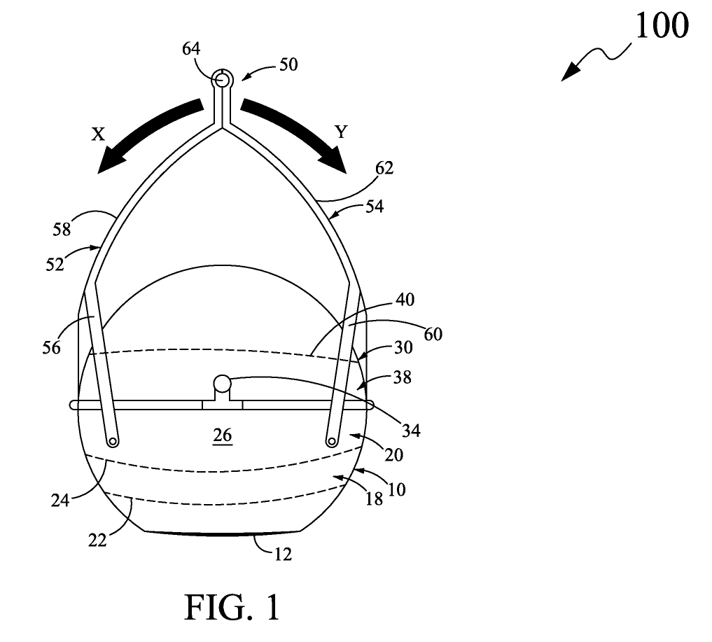

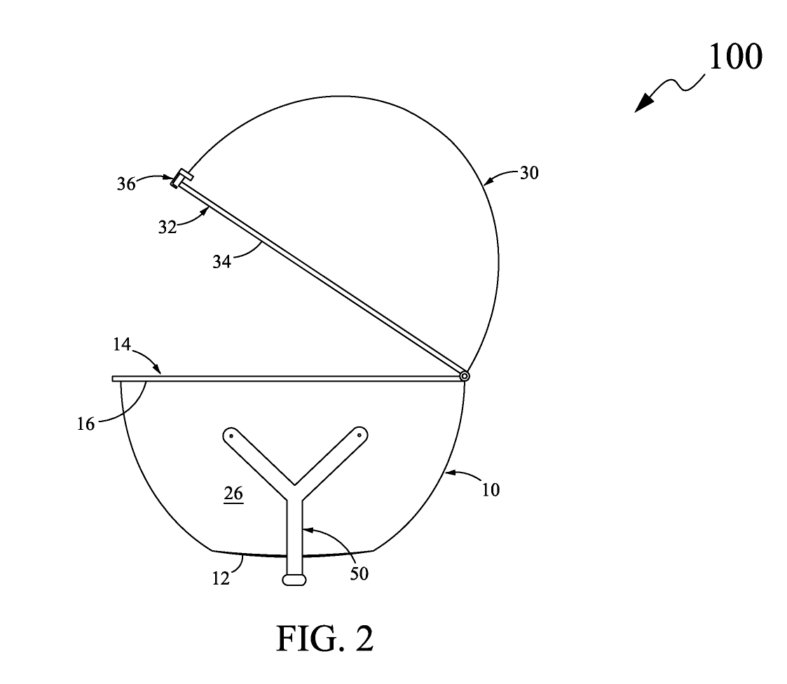

Referring now to FIGS. 1 and 2, there is shown one embodiment of a buoyant fishing tackle box 100 (hereinafter referred to as the box 100). The box 100 includes a lower body member 10, a complementary upper body member 30, and a pair handle members 50.

The lower body member 10 is substantially hemispherical in shape having a weighted base portion 12 and an open top portion 14 (as shown in FIG. 2). The open top portion 14 may include a rim 16 configured along an outer periphery thereof. The base portion 12 may be weighted for enabling the box 100 to remain in an upright position. In one embodiment of the present disclosure, the base portion 12 may be weighted by integrally thickening base portion of the lower body member 10 by means of a conventionally known process or by using a conventionally known material. For example, the base portion 12 may be weighted by constructing the same from a volume of dense material.

The lower body member 10 is made substantially hemispherical in shape for providing sufficient buoyant force, when the fishing tackle box 100 is accidentally dropped in water. Alternatively, the lower body member 10 may be configured in any other shape that provides sufficient buoyancy to the box 100. Further, the lower body member 10 may be hollow in construction such that the hollow lower body member 10 configures a space (not shown) therewithin. The space configured within the lower body member 10 may be partitioned to configure a plurality of compartments, such as a compartment 18 and a compartment 20 (shown in FIG. 1).

Each compartment of the plurality of compartments may hold at least one fishing tackle (not shown) therein. In an embodiment of the present disclosure, the compartments may be formed by partitioning the space by means of trays. For example, as illustrated in FIG. 1, a tray 22 and a tray 24 may collectively partition the space within the lower body member 10 to form multiple compartments, such as the compartments 18, 20.

As disclosed herein, the trays 22, 24 may be removably disposed within the lower body member 10 for forming multiple compartments that may hold the fishing tackles therein. The trays 22, 24 may be shaped to align to the inner periphery of the lower body member 10. Each of the removable trays 22, 24 provide easy placement and removal of the fishing tackles in the fishing tackle box 100. Further, the trays 22, 24 may be configured with a cover (not shown) thereon for restricting the cluttering of the fishing tackles stored therein. The trays 22, 24 may be made of a durable material such as plastic, aluminum, steel and the like.

The lower body member 10 may be made of a water resistant material such as hard plastic, aluminum, steel and the like. Alternatively, the lower body member 10 may be made of any other durable and water resistant material such as alloy and the like. Further, the lower body member 10 may be made in red color. Alternatively, the lower body member 10 may be configured in a variety of colors for enhancing an aesthetic value thereof.

The box 100 also includes the upper body member 30. The upper body member 30 is hemispherical in shape having an open bottom end portion 32. The open bottom end portion 32 of the upper body member 30 may include a rim 34 configured along a periphery thereof, and a fastener 36 disposed on the rim 34. The upper body member 30 may be configured and dimensioned to act as a lid for covering the lower body member 10 such that the rim 16 of the lower body member 10 may engage with the rim 34 of the upper body member 30. Specifically, the engagement of the rim 16 and rim 34 provides a water tight construction to the box 100. Moreover, the fastener 36 facilitates removable engagement of the upper body member 30 with the lower body member 10.

Referring specifically to FIG. 2, in the present embodiment, the upper body member 30 is connected to the lower body member 10. More specifically, each of the upper body member 30 and the lower body member 10 are suitably fastened to each other at a portion of the respective rims 34, 16 thereof. Further, the fastener 36 disposed on the rim 34 of the upper body member 30 may be removably engaged with the rim 16 of the lower body member 10 to lock the upper body member 30 on the lower body member 10. In an embodiment of the present disclosure, the fastener 36 is a hook. Alternatively, the fastener 36 may be a clasp, press-button lock and the like.

The upper body member 30 may be hollow in construction, thereby configuring a space therewithin. The space configured within the upper body member 30 may be partitioned to form a plurality of compartments, such as a compartment 38 for holding fishing tackles (not shown). The partitions may be configured by means of a meshed tray, such as a tray 40. The tray 40 may be removably disposed within the upper body member 30 for holding the fishing tackles therein. The removable tray 40 within the upper body member 30 provides easy placement and removal of the fishing tackles in the box 100. The tray 40 may be made of durable material such as plastic, aluminum, steel and the like.

The upper body member 30 may be made of a durable and water resistant material such as hard plastic, aluminum, steel and the like. Alternatively, the upper body member 30 may be made of any other durable and water resistant material known in art. Moreover, the upper body member 30 may be made in white color. Alternatively, the upper body member 30 may be configured in a variety of colors for enhancing an aesthetic value thereof.

The box 100 also includes the pair of handle members 50 pivotally attached to an outer surface 26 of the lower body member 10 at diametrically opposite locations, as shown in FIG. 1. The pair of handle members 50 facilitates holding and carrying of box 100. In the present embodiment, the pair of handle members 50 includes a handle member 52 and a handle member 54, each having a linear portion and a curved portion extending from the linear portion. For example, the handle member 52 includes a linear portion 56 and a curved portion 58. Further, the handle member 54 includes a linear portion 60 and a curved portion 62. Each of the curved portions 58, 62 bends inwardly in a closed position and unite collectively to form an apex. The apex so formed may also configure an opening 64 for suspending the box 100 in a boat or on a dock.

Each handle member such as the handle member 52, 54 may be detached from each other at the apex and moved away along the direction of the arrows X and Y, as shown in FIG. 1. Upon completely moving the handle members 52, 54 along the arrows X and Y, the handle members 52, 54 assumes a collapsed position which is best depicted in FIG. 2. In the collapsed position thereof, the handle members 52, 54 allow easy opening of the upper body member 30 from the lower body member 10 for placing and retrieving the fishing tackles therein. The pair of handle members 50 may be made of any durable material such as plastic, wood, metal and the like. In an alternative embodiment, the pair of handle members 50 may include a pair of straps (not shown) or a single strap for convenient carrying of the box 100 by a fisherman or an individual indulging in fishing activities. The strap may be made of woven material having like color of the lower body member 10.

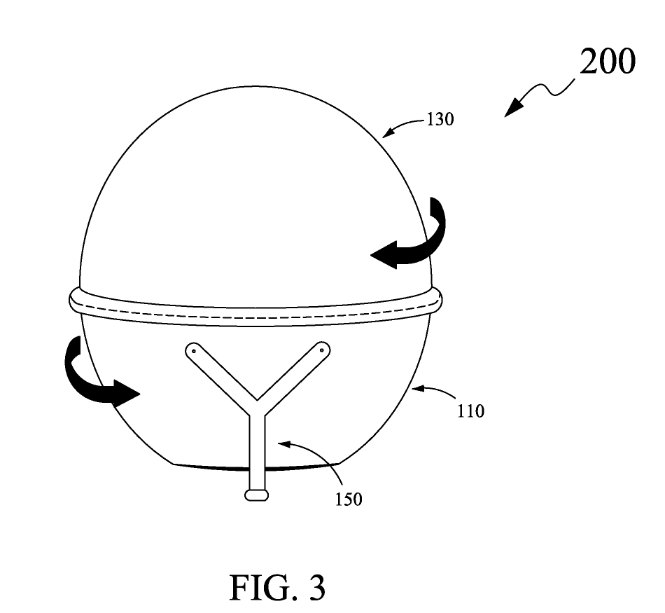

Referring now to FIG. 3, another embodiment of the fishing tackle box 200 is shown. The fishing tackle box 200 includes a lower body member 110, the upper body member 130 and a handle member 150. The lower body member 110, the upper body member 130 and the handle member 150 may be similar to the lower body member 10, the upper body member 30 and the handle member 50, respectively, of FIGS. 1 and 2. Accordingly, for the sake of brevity, the lower body member 110, the upper body member 130 and the handle member 150 of the fishing tackle box 100 are not described herein.

As shown in FIG. 3, the upper body member 130 may be detachably coupled to the lower body member 110. More specifically, in the present embodiment, the lower body member 110 may include grooves (not shown) along the outer peripheral edge portion thereof, and the upper body member 130 may include corresponding notches (not shown) on the inner peripheral edge. Accordingly, when the upper body member 130 is rotated in a twisting manner (as shown by means of arrows in FIG. 3) on the lower body member 110, the notches fits on the corresponding grooves to detachably couple the upper body member 130 to the lower body member 110.

In an embodiment of the present disclosure, the height of the fishing tackle box 100 may be about 13 inches. Moreover, thickness of each of the rim 16, 34 may be about ¼ of an inch. However, the dimensions of the disclosed fishing tackle box, such as the box 100 and the box 200 may vary based on the requirement and construction thereof.

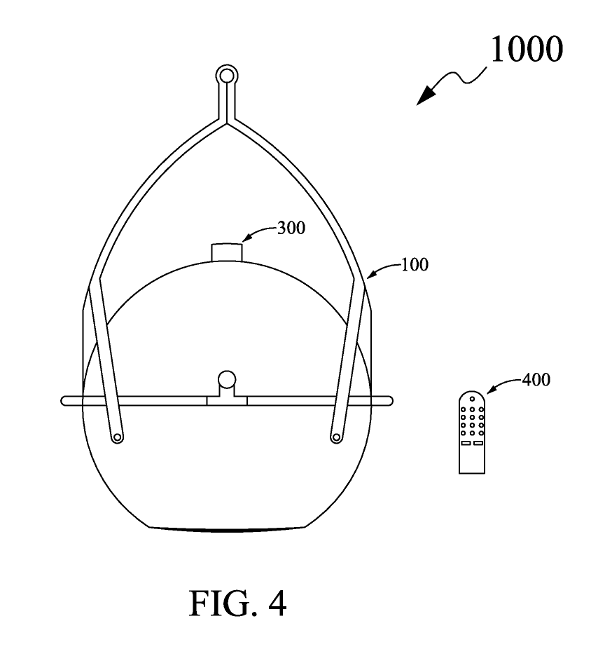

Now referring to FIG. 4, a buoyant fishing tackle box package 1000 (hereinafter referred to as package 1000) is provided. The package 1000 includes a fishing tackle box, such the box 100, a location detection system 300 and a control device 400. The location detection system 300 is disposed on one of the lower body member 10 and the upper body member 30 of the box 100. As shown in FIG. 4, the location detection system 300 may be disposed on the upper body member 30. The location detection system 300 facilitates detection of location of the fishing tackle box, such as the box 100. The location detection system 300 may include a signal generating unit (not shown) and a signal transmitting unit (not shown) that may collectively function similar to Global Positioning System (GPS) system known in the art. Further, the control device 400 may be similar to a remote control device known in the art that may activate the location detection system 300 to generate and transmit the signals such as the light signal, the sound signal and the like.

In use, when the fishing tackle box, such as the box 100, is misplaced or accidentally dropped in water, an individual such as a fisherman may operate the remote control device 400, which may in turn activate the location detection system 300 disposed on the box 100. In turn, the location detection system 300 may generate a light signal or a sound alarm to reveal the location of the fishing tackle box 100 to the individual.

In the present embodiment, the package 1000 is shown and explained with reference to the box 100. Alternatively the package 1000 may include the box 200 instead of the box 100, so that the location detection system 300 and the remote control device 400 may still perform the same steps and functions thereof without departing from the scope and teachings of the present disclosure.

The fishing tackle box, such as the fishing tackle box 100 or the fishing tackle box 200, and the fishing tackle box package 1000 offer following advantages. The disclosed fishing tackle box is capable of floating in water when accidentally dropped in water while fishing due to its inventive design aspects thereof. Specifically, the substantially hemispherical upper body member and the lower body member removably couple together to provide a water tight construction to the fishing tackle box. Further, the weighted base portion of the lower body member of fishing tackle box allows the fishing tackle box to stand upright on a flat surface and upon being accidentally dropped in water. Furthermore, the location detection system disposed on the fishing tackle box may enable a fisherman to locate the misplaced fishing tackle box by providing a signal alarm such a light, a sound alarm and the like upon being activated by a remote control device.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A buoyant fishing tackle box comprising:
a lower body member comprising a weighted base portion and an open top end portion, the lower body member being hollow and substantially hemispherical in shape, thereby defining a space therewithin, the space being partitioned to configure a plurality of compartments, each compartment of the plurality of compartments capable of holding at least one fishing tackle therein;
an upper body member comprising an open bottom end portion, the upper body member being hollow and substantially hemispherical in shape, the open bottom end portion of the upper body member capable of being removably engaged with the open top end portion of the lower body member for closing the upper body member on the lower body member; and
a pair of handle members attached to an outer surface of the lower body member, wherein the weighted base portion enables the buoyant fishing tackle box to remain in an upright position.

2. The buoyant fishing tackle box of claim 1, wherein the upper body member is configured to hold a plurality of fishing tackles therein.

3. The buoyant fishing tackle box of claim 1, wherein at least one of the plurality of compartments of the lower body member is removably disposed within the lower body member.

4. A buoyant fishing tackle box package comprising:
a buoyant fishing tackle box comprising
a lower body member comprising a weighted base portion and an open top end portion, the lower body member being hollow and substantially hemispherical in shape, thereby defining a space therewithin, the space being partitioned to configure a plurality of compartments, each compartment of the plurality of compartments capable of holding at least one fishing tackle therein,
an upper body member comprising an open bottom end portion, the upper body member being hollow and substantially hemispherical in shape, the open bottom end portion of the upper body member capable of being removably engaged to the open top end portion of the lower body member for closing the upper body member on the lower body member, and
a pair of handle members attached to an outer surface of the lower body member, wherein the weighted base portion enables the buoyant fishing tackle box to remain in an upright position;
a location detection system disposed on one of the lower body member and the upper hollow body member, the location detection system facilitating detection of location of the buoyant fishing tackle box; and
a control device operatively coupled to the location detection system, the control device capable of activating the location detection system.

5. The buoyant fishing tackle box package of claim 4, wherein the upper body member of the buoyant fishing tackle box is configured to hold a plurality of fishing tackles therein.

6. The buoyant fishing tackle box package of claim 4, wherein at least one of the pluralities of compartments of the lower body member of the buoyant fishing tackle box is removably disposed within the lower body member.
